(19) United States
(12) Patent Application Publication
(10) Pub. No.: US 2020/0100493 A1
(43) Pub. Date: Apr. 2, 2020

(54) ORNAMENTAL GAME CALL AND METHOD MAKING THEREOF

(71) Applicant: Brian Matthew Rubenstein, Detroit Lakes, MN (US)

(72) Inventor: Brian Matthew Rubenstein, Detroit Lakes, MN (US)

(21) Appl. No.: 16/220,364

(22) Filed: Dec. 14, 2018

Related U.S. Application Data
(60) Provisional application No. 62/740,104, filed on Oct. 2, 2018.

(51) Int. Cl. A01M 31/00

(52) U.S. Cl. CPC A01M 31/004

(57) ABSTRACT

An ornamental game call and a method of making thereof. The game call includes a base having a cylinder shape with a top opening and a bottom opening. The base further includes a first inner edge along a length and a second inner edge along the length defining a slot therebetween. A barrel is disposed around an outer surface of the base. The barrel is made of a resin. A portion of the resin is disposed within the slot such that a bore is defined by an inner surface of the base and the portion of the resin disposed within the slot. An image or text is disposed in between the base and the barrel.

### CROSS-REFERENCE TO RELATED APPLICATION

This application claims the benefit of priority of U.S. provisional application No. 62/740,104, filed Oct. 2, 2018, the contents of which are herein incorporated by reference.

### BACKGROUND OF THE INVENTION

The present invention relates to a game call and, more particularly, to an ornamental game call and a method of making the game call.

A duck call is a tool which the person uses to produce a sound-imitation by which a hunter lures waterfowl. Early duck call tools were basic woodwind instruments, while later innovations are constructed of rubber and plastic, and allow the hunter to adjust the volume and tone of the calls with reeds. Today's duck calls usually fall into three main categories: a single, double, or triple reed call with many variations. The goal of a duck call is to sound like a realistic live duck.

Decorative duck calls feature a polycarbonate or acrylic tube which is wrapped with an image. Although this type of tube is manufactured as a specific size, resins are not able to fill the inner surface bore of the game call with precision and therefore creates an uneven, weakened, rough surface within the inner bore surface. These characteristics can create distortion upon air exiting the game call insert. Additionally, the current decorative duck calls include an image disposed on the tube with a noticeably unsightly seam.

As can be seen, there is a need for an improved method of making a duck call.

### SUMMARY OF THE INVENTION

In one aspect of the present invention, a game call comprises: a base having a cylinder shape with a top opening and a bottom opening, wherein the base comprises a first inner edge along a length of the base and a second inner edge along the length defining a slot therebetween; and a barrel disposed around an outer surface of the base, wherein the barrel is made of a resin, wherein a portion of the resin is disposed within the slot such that a bore is defined by an inner surface of the base and the portion of the resin disposed within the slot.

In another aspect of the present invention, a method of making a game call comprises steps of: providing a base having a cylinder shape with a top opening and a bottom opening, wherein the base comprises a first inner edge along a length of the base and a second inner edge along the length defining a slot therebetween; providing a mold comprising a mold cavity and a rod support slot defined at the bottom of the mold cavity; inserting an end of a rod into the rod support slot, wherein the rod support slot supports the rod vertically within the mold cavity; inserting the base into the mold cavity so that the rod inserts through the bottom opening and the top opening of the base; and pouring a liquid resin into the mold cavity, wherein the liquid resin surrounds the base and enters the slot of the base.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of an embodiment of the present invention;

FIG. 3 is a perspective view of an embodiment, illustrating a method of making the present invention;

FIG. 4 is a section view of the present invention, taken along line 4-4 in FIG. 3;

FIG. 5 is a perspective view of an embodiment, illustrating a method of making the present invention;

FIG. 6 is a section view of the present invention, taken along line 6-6 in FIG. 3;

FIG. 7 is a section view of an embodiment, illustrating a method of making the present invention;

FIG. 8 is a section detail view of an embodiment, illustrating a method of making the present invention;

FIG. 9 is a perspective view of an embodiment, illustrating a method of making the present invention;

FIG. 10 is a perspective view of an embodiment, illustrating a method of making the present invention; and

FIG. 11 is an exploded view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

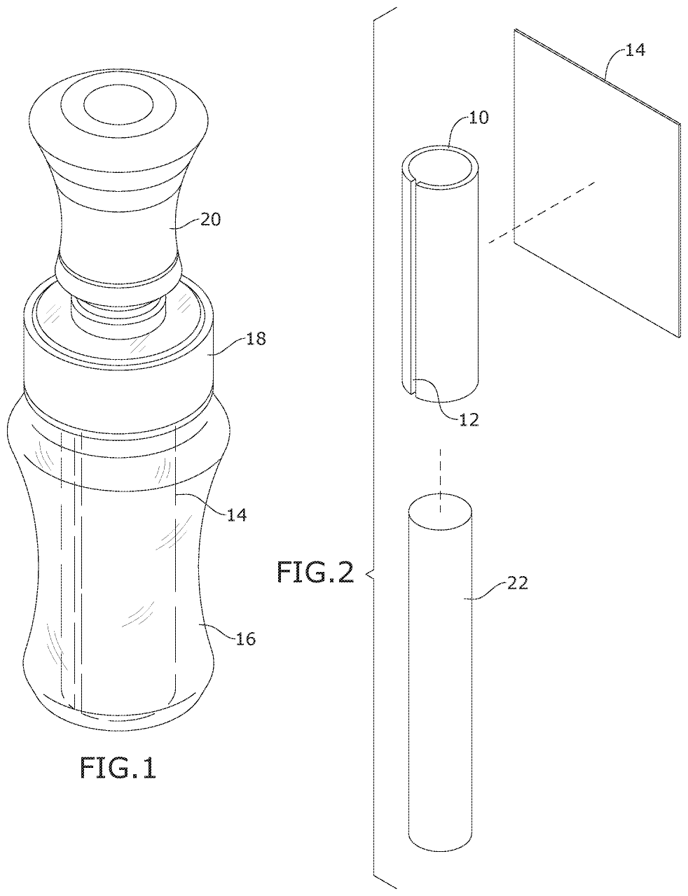

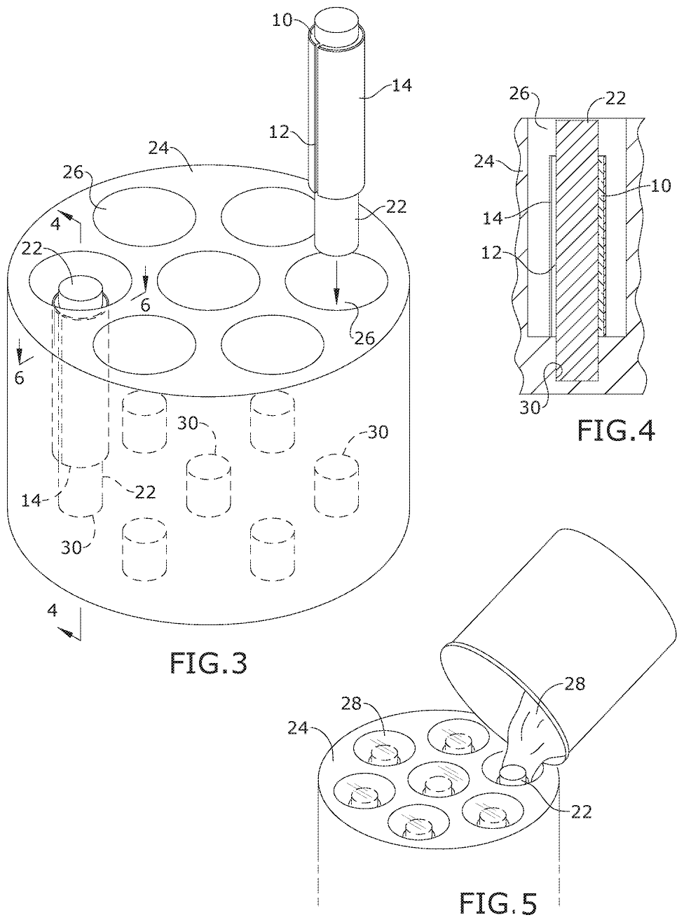

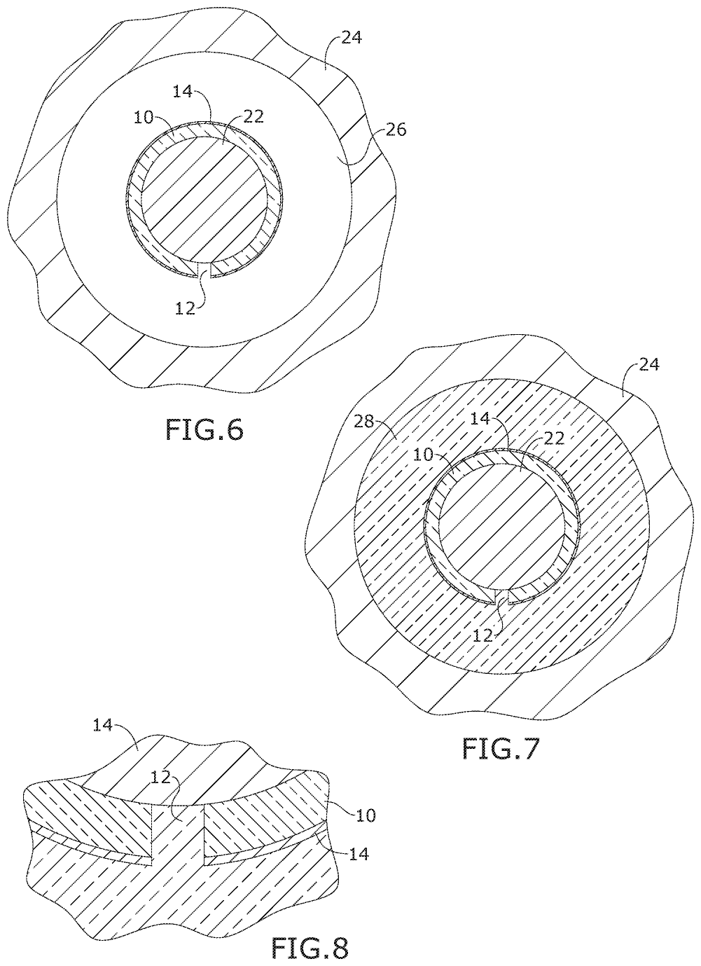

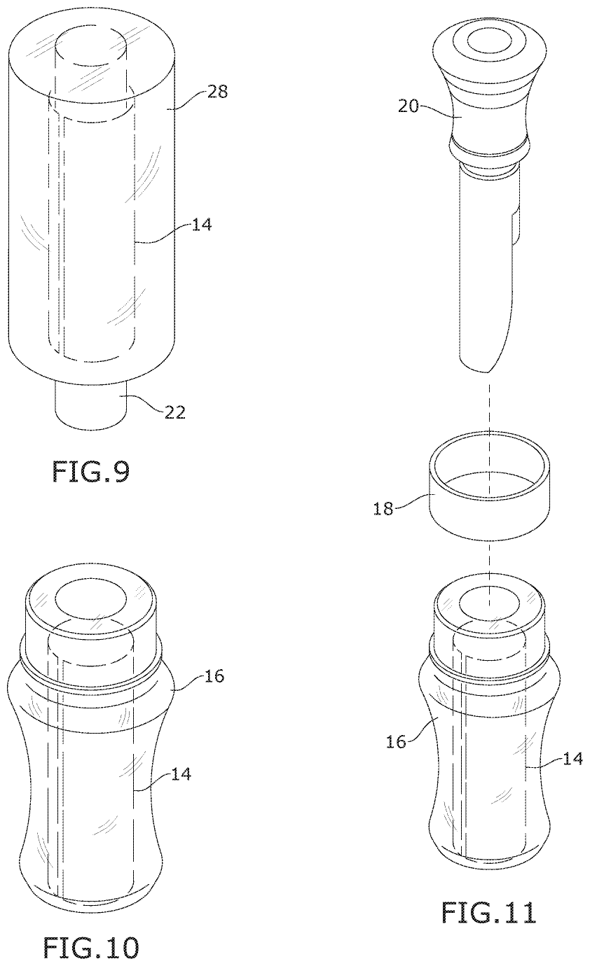

Referring to FIGS. 1 through 11, the present invention includes a game call and a method of making thereof. The game call includes a base 10 having a cylinder shape with a top opening and a bottom opening. The base 10 further includes a first inner edge along a length and a second inner edge along the length defining a slot 12 therebetween. A barrel 16 is disposed around an outer surface of the base 10. The barrel is made of a resin 28. A portion of the resin 28 is disposed within the slot 12 such that a bore is defined by an inner surface of the base 10 and the portion of the resin 28 disposed within the slot 12.

The base 10 of the present invention is a curved (semicircular) carbon fiber, acrylic, or polycarbonate disposed within the barrel 16 of the game call. The slot 12 is comprised of a 2 mm-3 mm gap between the inner edges. The base 10 may then be cut into about a 2¾″ to 3″ section or left in longer lengths so as to create CNC ready acrylic rods.

Utilizing the method of an open, curved, or semicircular carbon fiber, acrylic, or polycarbonate surface allows the bore to be smooth, stronger, and even. The smooth and even surface of the bore allows for consistent air to be pushed through the game call upon the user blowing air through said game call. A smooth wall bore allows the present invention to exhaust all air blown by the user. Further, the slot 12 allows for even distribution of resins 28 within the bore and allows for a game call to weigh less than some other game calls.

The present invention may further include a sheet 14 placed on the base 10. The sheet 14 includes a first terminal end, a second terminal end, and an image or text. The sheet 14 is placed upon the base 10 so that the first terminal end is aligned with the first inner edge and the second terminal end is aligned with the second inner edge. The sheet 14 is disposed in between the base 10 and the barrel 16. The ornamental game call of the present invention is thereby created without a seam where an image or text ends around a closed cylindrical surface. Instead, the present invention allows the imagery to stop at the slot 12. The present invention also allows the method of wrapping the entire surface of the base 10. The image of the sheet 14 is visible through a transparent resin 28.

A method of making an ornamental game call may include the following. Provide the base 10 described above. Provide a mold 24 having at least one mold cavity 26 and a rod support slot 30 defined at the bottom of the mold cavity 26. Each mold cavity may be approximately 1.25″ to 1.75″ in diameter. Insert an end of a rod 22 into the rod support slot 30. The rod support slot 30 supports the rod vertically within the mold cavity 26. The rod 22 may be a ⅝ stainless steel rod measuring anywhere from 3″ tall to 48″ tall. This step depends on whether the user desires a single blank or an entire rod 22 that can be cut to desired lengths. Insert the base 10 into the mold cavity 26 so that the rod 22 inserts through the bottom opening and the top opening of the base 10. Pour a liquid resin 28 into the mold cavity 26. The liquid resin 28 surrounds the base 10 and enters the slot 12 of the base 10. The mold 24 is placed within pressurized casting equipment for the amount of time as recommended by the resin manufacturer.

In certain embodiments, prior to pouring the liquid resin 28 into the mold cavity 26, the method further includes wrapping or adhering the sheet 14 to an outer surface of the base 10 so that the first terminal end is aligned with the first inner edge and the second terminal end is aligned with the second inner edge. An image or text is now disposed on the outer surface of the base 10. The base 10 shows an opening as to where the image or text ends and eliminates the unsightly seam which creates an overlapped image. The user also has the option to place an image or text around the base 10 if the chosen design requires said style of image placement.

The method may further include the step of removing a hardened resin 28, the base 10, and the rod 22 from the mold cavity 26. Upon reaching the recommended cure time for said resins 28, each mold is removed from the pressurized casting equipment. A bore is defined by an inner surface of the base 10 and a portion of the hardened resin 28 disposed within the slot 12. If rods 22 are produced in casting, each rod 22 is then cut into individual sections (also known as “blanks”). Each blank is placed on a mandrel, located on a lathe or within a CNC style machine, and the outer surface of said blank is shaped to the desired form or design, i.e. an outer surface of the hardened resin 28 is shaped to form the barrel 14 of the game call. Upon shaping each blank, the game call receives the insert of the call within the bore, a decorative ring 18 and an insert 20.

It should be understood, of course, that the foregoing relates to exemplary embodiments of the invention and that modifications may be made without departing from the spirit and scope of the invention as set forth in the following claims.

What is claimed is:

1. A game call comprising:
a base having a cylinder shape with a top opening and a bottom opening, wherein the base comprises a first inner edge along a length of the base and a second inner edge along the length defining a slot therebetween; and
a barrel disposed around an outer surface of the base, wherein the barrel is made of a resin, wherein a portion of the resin is disposed within the slot such that a bore is defined by an inner surface of the base and the portion of the resin disposed within the slot.

2. The game call of claim 1, further comprising a sheet comprising a first terminal end, a second terminal end, and an image or text, wherein the sheet is placed on the base so that the first terminal end is aligned with the first inner edge and the second terminal end is aligned with the second inner edge, wherein the sheet is disposed in between the base and the barrel.

3. The game call of claim 1, further comprising an insert coupled to the barrel at the top opening of the base.

4. A method of making a game call comprising steps of:
providing a base having a cylinder shape with a top opening and a bottom opening, wherein the base comprises a first inner edge along a length of the base and a second inner edge along the length defining a slot therebetween;
providing a mold comprising a mold cavity and a rod support slot defined at the bottom of the mold cavity;
inserting an end of a rod into the rod support slot, wherein the rod support slot supports the rod vertically within the mold cavity;
inserting the base into the mold cavity so that the rod inserts through the bottom opening and the top opening of the base; and
pouring a liquid resin into the mold cavity, wherein the liquid resin surrounds the base and enters the slot of the base.

5. The method of claim 4, further comprising a step of adhering a sheet to an outer surface of the base prior to pouring the liquid resin into the mold cavity, wherein the sheet comprises a first terminal end, a second terminal end, and an image, wherein the sheet is placed on the base so that the first terminal end is aligned with the first inner edge and the second terminal end is aligned with the second inner edge.

6. The method of claim 4, further comprising a step of removing a hardened resin, the base, and the rod from the mold cavity.

7. The method of claim 6, further comprising a step of removing the rod from the base, wherein a bore is defined by an inner surface of the base and a portion of the hardened resin disposed within the slot.

8. The method of claim 7, further comprising a step of shaping an outer surface of the hardened resin to form a barrel of the game call.

9. The method of claim 8, further comprising a step of attaching an insert to the barrel.

10. The method of claim 9, further comprising a step of attaching a decorative sleeve around the barrel.
